(19) United States
(12) Patent Application Publication
(10) Pub. No.: US 2023/0367785 A1
(43) Pub. Date: Nov. 16, 2023

(54) SYSTEM, METHOD FOR IMPROVING EFFICIENCY OF YANG DATA MODEL-BASED NETWORK DEVICES

(71) Applicant: HUAWEI TECHNOLOGIES CO., LTD., Shenzhen (CN)

(72) Inventors: Jian LI, Mississauga (CA); Xiang JI, Ottawa (CA); Danni SHANG, Richmond Hill (CA); Cong Lin FAN, Markham (CA)

(21) Appl. No.: 17/740,850

(22) Filed: May 10, 2022

(51) Int. Cl. G06F 16/25; G06F 16/21

(52) U.S. Cl. CPC G06F 16/258; G06F 16/212

(57) ABSTRACT

The disclosed systems and methods are directed towards: i) receiving at least one Yet Another Next Generation (YANG) data model, ii) converting the at least one YANG data model into a corresponding Forest Data Store (FDS) binary format, wherein the FDS binary format is divided into four areas: forest data area, meta-data area, string area, and dynamic area, and iii) transmitting the FDS binary format to at least one of: a server-network device and a client device/network management system. The systems and methods are also directed towards: i) receiving a request for configuration of the server-network device, and ii) processing the request based on the FDS binary format corresponding to at least one YANG data model.

### CROSS-REFERENCE TO RELATED APPLICATIONS

This is the first application filed for the instantly disclosed technology.

### TECHNICAL FIELD

The present disclosure generally relates to networking and, in particular, to a system, and a method for improving efficiency of YANG data model-based network devices.

### BACKGROUND

Yet Another Next Generation (YANG) is a data modeling language for the definition of data sent over network management protocols such as NETCONF and RESTCONF described by IETF RFC 6020 (YANG 1.0) and RFC 7950 (YANG 1.1). YANG data model is used to model configuration data, operation data, and Remote Procedure Calls (RPC). YANG data model describes equipment capabilities and status, facilitating device configuration via management software.

YANG data model can include Extensible Markup Language (XML), JavaScript Object Notation (JSON), etc. formatted as a data model to provide a text format Operations, Administration, and Maintenance (OAM) interface, to configure and monitor network devices. However due to the text format, i.e., human-readable format, the efficiency is very low when it is used to control or monitor a major network device, such as a core internet router or Multiprotocol Label Switching (MPLS) switch.

One downside of YANG data model is that its models are based on a text format. This results in low parsing and loading efficiency when using computer languages such as C/C++. The complicated semantics and syntax of the YANG data model is not conducive to designing efficient equipment configuration management software.

Existing solutions include open-source software and proprietary software developed by major network device providers, which parse the YANG data model source file and store the processed output into pre-existing databases such as relational databases. The design principles of these databases do not conform to the tree-like nested structure of the YANG data model language, resulting in low data addition, deletion, modification, and querying efficiency; low XPath retrieval efficiency; and low verification efficiency. Additionally, there is also a high memory requirement. This impacts the YANG data model applicability on high-end network devices, for example, it can extend device restart time, cause slow user query response, and high processor and network utilization.

With this said, there is an interest in improving efficiency of YANG data model-based network devices.

### SUMMARY

The embodiments of the present disclosure have been developed based on developers' appreciation of shortcomings associated with the prior art. By way of example, one downside of YANG data model is that the associated models are based on a text format resulting in low parsing and loading efficiency when using computer languages such as C/C++. The complicated semantics and syntax of the YANG data model is not conducive to designing efficient device configuration management software. Thereby, using YANG data model in its original format may degrade performance of the server-network device and/or the client device/network management system. To this end, developers of the present technology have devised systems and methods for improving efficiency of YANG data model-based network devices.

In accordance with the first broad aspect of the present disclosure, there is provided a method comprising: receiving at least one Yet Another Next Generation (YANG) data model; converting the at least one YANG data model into a corresponding Forest Data Store (FDS) binary format, wherein the FDS binary format is divided into four areas: forest data area, meta-data area, string area, and dynamic area; and transmitting the FDS binary format to at least one of: a server-network device and a client device/network management system.

In accordance with any embodiments of the present disclosure, the meta-data includes attributes specific to the at least one YANG data model.

In accordance with any embodiments of the present disclosure, the meta-data includes nodes that are used as definitions for other nodes in the at least one YANG data model.

In accordance with any embodiments of the present disclosure, the forest data includes a tree structure corresponding to the at least one YANG data model.

In accordance with any embodiments of the present disclosure, string values in the at least one YANG data model are converted into hash codes and the hash codes are stored in one or more of the forest data area, the meta-data area, the string area and the dynamic area.

In accordance with any embodiments of the present disclosure, the string area includes mappings from the hash codes to the string values.

In accordance with any embodiments of the present disclosure, the string area includes information regarding string length and compression flag in the string values.

In accordance with any embodiments of the present disclosure, the dynamic area includes list nodes and leaf-list nodes associated with the at least one YANG data model.

In accordance with any embodiments of the present disclosure, the FDS binary format is a machine-readable format.

In accordance with any embodiments of the present disclosure, constant values, node operators, and pre-defined functions associated with the at least one YANG data model defined as infix order are converted to postfix order in the FDS binary format.

In accordance with any embodiments of the present disclosure, the method further comprises converting XPath strings in the at least one YANG data model to hash codes and the hash codes are used as a global identifier for each node in the YANG data model.

In accordance with any embodiments of the present disclosure, the method further comprises replacing custom created typedef in the at least one YANG data model by built-in type(s).

In accordance with any embodiments of the present disclosure, the method further comprises merging sub-modules associated with the at least one YANG data model.

In accordance with any embodiments of the present disclosure, the method further comprises importing of content associated with other YANG data models to the FDS binary format.

In accordance with any embodiments of the present disclosure, the method further comprises performing node-augmentation directly to nodes associated with the at least one YANG data model.

In accordance with any embodiments of the present disclosure, the method further comprises performing node-deviation directly to nodes associated with the at least one YANG data model.

In accordance with any embodiments of the present disclosure, the method further comprises reusing of uses-grouping.

In accordance with the second broad aspect of the present disclosure, there is provided a method comprising: receiving, by a server-network device, a request for configuration of the server-network device; and processing the request based on a Forest Data Store (FDS) binary format corresponding to at least one Yet Another Next Generation (YANG) data model, wherein the FDS binary format includes four areas: forest data area, meta-data area, string area, and dynamic area.

In accordance with the third broad aspect of the present disclosure, there is provided a system comprising: a non-transitory memory element having instructions thereon; one or more processor coupled to the non-transitory memory element to execute the instructions to cause the one or more processor to: receive at least one Yet Another Next Generation (YANG) data model; convert the at least one YANG data model into a corresponding Forest Data Store (FDS) binary format, wherein the FDS binary format is divided into four areas: forest data area, meta-data area, string area, and dynamic area; and transmit the FDS binary format to at least one of: a server-network device and a client device/network management system.

In accordance with the fourth broad aspect of the present disclosure, there is provided a server-network device comprising: a non-transitory memory element having instructions thereon; one or more processor coupled to the non-transitory memory element to execute the instructions to cause the one or more processor to: receive a request for configuration of the server-network device; and process the request based on a Forest Data Store (FDS) binary format corresponding to at least one Yet Another Next Generation (YANG) data model, wherein the FDS binary format includes four areas: forest data area, meta-data area, string area, and dynamic area.

### BRIEF DESCRIPTION OF THE FIGURES

Further features and advantages of the present disclosure will become apparent from the following detailed description, taken in combination with the appended drawings, in which:

FIG. 1 depicts an environment including network devices for use with systems and methods, in accordance with various embodiments of the present disclosure;

FIG. 2A depicts a high-level block diagram of components of the client device/network management system, in accordance with various embodiments of the present disclosure;

FIG. 2B depicts a high-level functional block diagram of a server-network device of environment of FIG. 1, in accordance with various embodiments of the present disclosure;

FIG. 3 illustrates a system for conversion of Yet Another Next Generation (YANG) data models to Forest Data Store (FDS) binary format, in accordance with various non-limiting embodiments of the present disclosure;

FIG. 4 illustrates a representative environment including network devices for use with systems and methods, in accordance with various embodiments of the present disclosure;

FIG. 5 illustrates another representative environment including network devices for use with systems and methods, in accordance with various embodiments of the present disclosure;

FIG. 6 depicts a flowchart representing a process corresponding to a method for improving efficiency of YANG data model-based network devices, in accordance with various embodiments of the present disclosure; and

FIG. 7 depicts a flowchart representing a process corresponding to a method for processing a configure request based on FDS binary format implementing on the server-network device.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims.

### DETAILED DESCRIPTION

The instant disclosure is directed to address at least some of the deficiencies of the current technology. In particular, the instant disclosure describes a system and method for improving efficiency of YANG data model-based network devices.

Unless otherwise defined or indicated by context, all technical and scientific terms used herein have the same meaning as commonly understood by one of ordinary skill in the art to which the described embodiments appertain to.

In the context of the present specification, “client device/network management system” is an application or set of applications that identifies, configures, monitors, updates and troubleshoots network devices either manually or automatically. Thus, some (non-limiting) examples of client device/network management systems can be deployed on computer servers, computer cluster, workstation, personal computers (desktops, laptops, netbooks, etc.), smartphones, and tablets, it may be a web-based application that may be used by a client. Further it is contemplated that the client device/network management system may be an automatic system in network automation and autonomous driving network scenarios. In certain non-limiting embodiments, may be a Software Defined Networking (SDN) controller, an Element Management System (EMS), a Craft Interface (CI) client, or the like. It should be noted that a device acting as a client device/network management system in the present context is not precluded from acting as a server-network device to other client device/network management systems. The use of the expression “a client device/network management system” does not preclude multiple client-device/network management systems being used in receiving/sending, carrying out or causing to be carried out any task or request, or the consequences of any task or request, or steps of any method described herein.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first processor” and “third processor” is not intended to imply any particular order, type, chronology, hierarchy or ranking (for example) of/between the server-network device, nor is their use (by itself) intended to imply that any “second server-network device” must necessarily exist in any given situation. Further, as is discussed herein in other contexts, reference to a “first” element and a “second” element does not preclude the two elements from being the same actual real-world element. Thus, for example, in some instances, a “first” server-network device and a “second” server-network device may be the same software and/or hardware, in other cases they may be different software and/or hardware.

It will be understood that when an element is referred to as being “connected” or “coupled” to another element, it can be directly or indirectly connected or coupled to the other element or intervening elements that may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the context of the present specification, when an element is referred to as being “associated with” another element, in certain embodiments, the two elements can be directly or indirectly linked, related, connected, coupled, the second element employs the first element, or the like without limiting the scope of present disclosure.

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the context of the present specification, the expression “data” includes data of any nature or kind whatsoever capable of being stored in a database. Thus, data includes, but is not limited to audiovisual works (images, movies, sound records, presentations etc.), data (location data, numerical data, etc.), text (opinions, comments, questions, messages, etc.), documents, spreadsheets, etc.

In the context of the present specification, unless provided expressly otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server-network device or plurality of server-network devices.

Software modules, modules, or units which are implied to be software, may be represented herein as any combination of flowchart elements or other elements indicating performance of process steps and/or textual description. Such modules may be executed by hardware that is expressly or implicitly shown.

With these fundamentals in place, the instant disclosure is directed to address at least some of the deficiencies of the current technology. In particular, the instant disclosure describes a system and method for improving efficiency of YANG data model-based network devices.

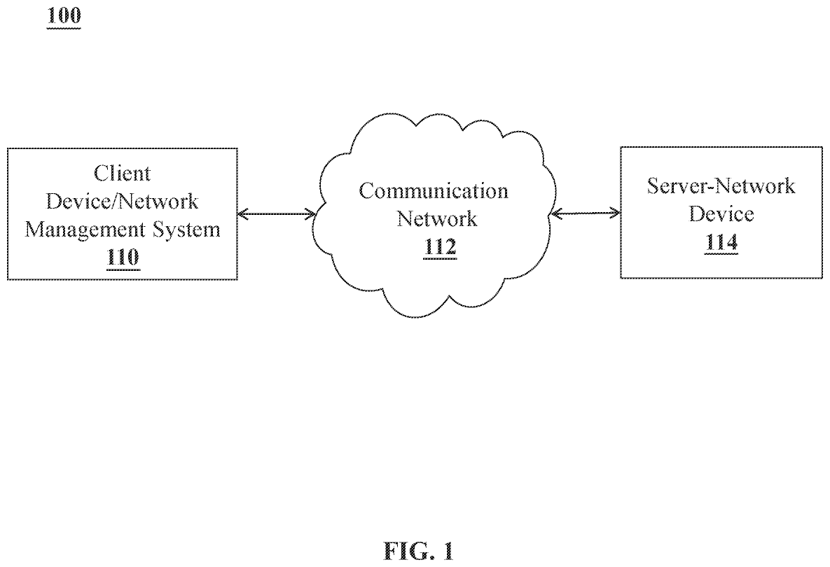

In particular, FIG. 1 depicts an environment 100 including network devices for use with systems and methods, in accordance with various embodiments of the present disclosure. The environment 100 may include multiple client device/network management systems 110 (for the purpose of simplicity only one client device/network management system 110 has been illustrated) located at different geographic locations that are configured to communicate with each other via a communication network 112 and multiple server-network devices 114 (for the purpose of simplicity only one server-network device 114 has been illustrated). In certain embodiments, multiple client device/network management systems 110 may be associated with individual users (such as users of personal computers, laptops, desktops, or the like) or a part of network (such as client device/network management systems in an organization, etc.).

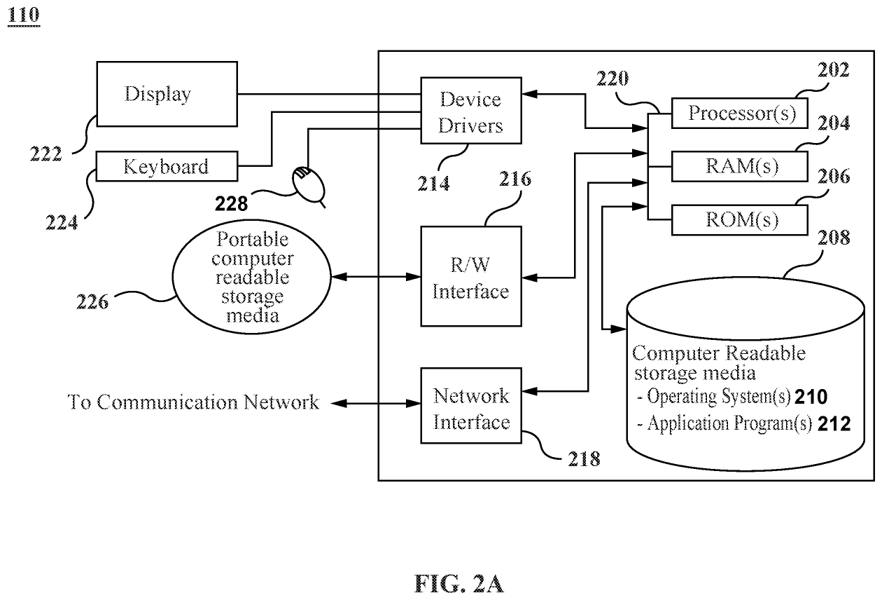

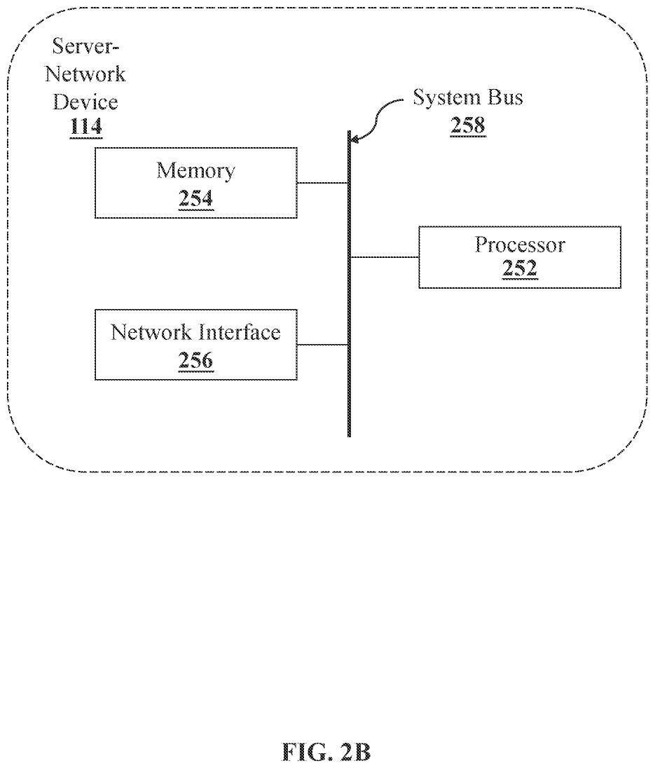

FIG. 2A depicts a high-level block diagram of components of the client device/network management system 110, in accordance with various embodiments of the present disclosure. It should be appreciated that FIG. 2A provides only an illustration of one implementation of client device/network management system 110 and does not imply any limitations with regard to the environments in which different embodiments may be implemented. Many modifications to the depicted environment can be done to implement client device/network management system 110 without departing from the principles presented herein. The client device/network management system 110 may be a server-network device, a desktop computer, a laptop computer, or any device that may be configured to implement the present technology, as should be understood by a person skilled in the art.

As shown, client device/network management system 110 employs one or more processors 202, one or more computer-readable random access memories (RAMs) 204, one or more computer-readable read only memories (ROMs) 206, one or more computer-readable storage media 208, device drivers 214, a read/write (R/W) driver interface 216, a network interface 218, all interconnected over a communication fabric 220. The communication fabric 220 may be implemented by any architecture designed for passing data and/or control information between processors (such as microprocessors, communications and network processors, etc.), system memory, peripheral devices, and any other hardware components within a system.

One or more operating systems 210 and one or more application programs 212 are stored on one or more of computer-readable storage media 208 for execution by one or more of the processors 202 via one or more of respective RAMs 204 (which typically include a cache memory). In the illustrated embodiment, each of the computer-readable storage media 208 may be a magnetic disc storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The R/W driver interface 216 reads from and writes to one or more portable computer-readable storage media 226. The application programs 212 may be related to improving efficiency of YANG data model-based network device and stored on one or more of portable computer-readable storage media 226, read via the respective R/W driver interface 216 and loaded into the respective computer-readable storage media 208.

Further, network interface 218 may be based on a TCP/IP adapter card or wireless communication adapter (such as a 4G wireless communication adapter using OFDMA technology). The application programs 212 on client device/network management system 110 may be downloaded to client device/network management system 110 from an external computer or external storage device via a communication network (for example, the Internet, a local area network or other wide area network or wireless network) and network interface 218. From network interface 218, application programs 212 may be loaded onto the computer-readable storage media 208. The client device/network management system 110 may connect to routers, firewalls, switches, gateway computers and/or edge server-network devices of the communication network using copper wires, optical fibers, wireless transmission, and the like.

The client device/network management system 110 may also include a display screen 222, a keyboard or keypad 224, and a computer mouse or touchpad 228. The device drivers 214 may interface with display screen 222 for imaging, with the keyboard or the keypad 224, with computer mouse or touchpad 228, and/or with display screen 222 (which may be a touch sensitive display) for alphanumeric character entry and user selections. The device drivers 214, R/W driver interface 216 and network interface 218 may comprise hardware and software (stored on the computer-readable storage media 208 and/or the ROM 206).

FIG. 2B depicts a high-level functional block diagram of server-network device 114 of environment 100 of FIG. 1, in accordance with various embodiments of the present disclosure. In one embodiment, the server-network device 114 may be a device that may consolidate a functionality of an Internet Router, a Multiprotocol Label Switching (MPLS) router or switch, a Multi-Service Provisioning Platform (MSPP), Digital Cross-Connect (DCS), Ethernet and/or Optical Transport Network (OTN) switch, Wave Division Multiplexed (WDM)/DWDM platform, Packet Optical Transport System (POTS), etc. into a single, high-capacity intelligent switching system. In another embodiment, the server-network device 114 may be any of an OTN Add/Drop Multiplexer (ADM), a Multi-Service Provisioning Platform (MSPP), a Digital Cross-Connect (DCS), an optical cross-connect, a POTS, an optical switch, a router, a switch, a WDM/DWDM terminal, an access/aggregation device, a wireless base station, etc. That is, the server-network device 114 may be any of digital, wireless (Radio Frequency (RF)), and/or optical system including switching of channels, timeslots, tributary units, wavelengths, etc. Also, the server-network device 114 may be a physical device as well as a virtual device (e.g., Virtual Network Function (VNF)).

It is contemplated that the server-network device 114 may communicate with other server-network devices 114 such as, without limitation, a Software-Defined Networking (SDN) controller, an orchestrator, a Network Management System (NMS), and Element Management System (EMS), etc.

In certain non-limiting embodiments, the server-network device 114 may include a processor 252, a memory 254 and a network interface 256. It is to be noted that the server-network device 114 may include other components, but such components have been not been illustrated in FIG. 2B for the purpose of simplicity.

In certain non-limiting embodiments, the processor 252 of server-network device 114 may include one or more of a CPU, an accelerator, a microprocessor, a GPU, an ASIC, a FPGA, a dedicated logic circuitry, a dedicated artificial intelligence processor unit, or combinations thereof.

The memory 254 may include volatile memory (e.g., RAM) and non-volatile or non-transitory memory (e.g., a flash memory, magnetic storage, and/or a ROM). The non-transitory memory(ies) stores a platform that controls the overall operation of server-network device 114. The platform, when executed by processor 252, implements application programs related to improving efficiency of YANG data model-based network device.

The network interface 256 may include one or more wireless transceivers configured for wireless communications with communication network 112, or one or more network adaptors configured for wired communications with communication network 112. In general, network interface 256 may be configured to correspond with the network architecture of that is used to implement a link for communications between server-network device 114 and communication network 112. In certain embodiments, network interface 256 may be implemented in a similar manner as network interface 218 has been implemented.

The server-network device 114 may include a system bus 258 for communicatively coupling the processor 252, the memory 254 and the network interface 256 to one another. For example, the system bus 258 may be a backplane, midplane, a bus, optical and/or electrical connectors, or the like.

It is to be noted that server-network device 114 is shown as a standalone computer. However, the implementation of various other embodiments of the present disclosure may include any client-server-network device model where client device/network management system 110 may run a client version of the application programs related to improving the efficiency of YANG data model-based network devices. Other examples of server-network device 114 may include a distributed computing system that runs the server-network device version of the application programs related to improving the efficiency of YANG data model-based network devices, a virtual machine (or virtual machines) instantiated by the infrastructure of a public or private cloud, or a cloud service provider that provides the application programs related to improving the efficiency of YANG data model-based network devices as a service (SaaS). Such implementations or any other similar implementation should not limit the scope of the present disclosure.

As previously discussed, YANG is a data modeling language for the definition of data sent over network management protocols such as NETCONF and RESTCONF. The YANG data modeling language is maintained by the NETMOD working group in the Internet Engineering Task Force (IETF) and initially was published as RFC 6020, with an update RFC 7950.

YANG data model can be used to model both configuration data as well as state data of network devices. Furthermore, YANG data model can be used to define the format of event notifications emitted by network elements and it allows data modelers to define the signature of remote procedure calls that can be invoked on network devices via the NETCONF protocol. The language, being protocol independent, can then be converted into any encoding format, e.g. XML or JSON, that the network configuration protocol supports.

One downside of YANG data model is that the associated models are based on a text format resulting in low parsing and loading efficiency when using computer languages such as C/C++. The complicated semantics and syntax of the YANG data model is not conducive to designing efficient device configuration management software. Thereby, using YANG data model in its original format may degrade performance of the server-network device 114 and/or the client device/network management system 110.

Several conventional techniques such as Relational Database, Graph Database, and Load Source YANG File have several deficiencies. By way of example, YANG data model is a tree data structure. It is very cumbersome to convert YANG data model to the relational database's table structure and foreign key relationships. This results in a very complicated tables and foreign keys, and the data query SQL script will be complex and have low query efficiency. Further, a new database schema has to be designed for each module.

Further, YANG nodes have specific relationships with one another. However, when using a graph database to store nodes and relationships, the database will generalize them into vertices and edges. This means that all nodes and relationships are included in each query, irrespective of whether the nodes are directly related to the query or not, thereby, degrading the performance of the server-network device 114.

Moreover, YANG semantics and syntax are complicated. It is necessary to parse text-based data and simultaneously analyze the data's semantics and syntax, resulting in very low performance.

With this said, there is an interest in developing systems and methods for improving efficiency of YANG data model-based network devices (for example, the server-network device 114 and/or the client device/network management system 110).

In various non-limiting embodiments of the present disclosure, the YANG data model is converted into a binary file in accordance with Forest Data Store (FDS) binary format. By converting YANG data models into FDS binary format, it is possible to preserve and store each model's data structures, data constraints, and inter-model data relationships while eliminating complicated semantics and syntax. Further by converting YANG data models into FDS binary format instead of using the original text-based format, efficiency and data querying and retrieval times of YANG data model-based network devices (for example, the server-network device 114 and/or the client device/network management system 110) may be significantly improved. Further, the FDS binary format may also incorporate other features and algorithms to improve data storage and retrieval (details of which will be discussed later in the disclosure).

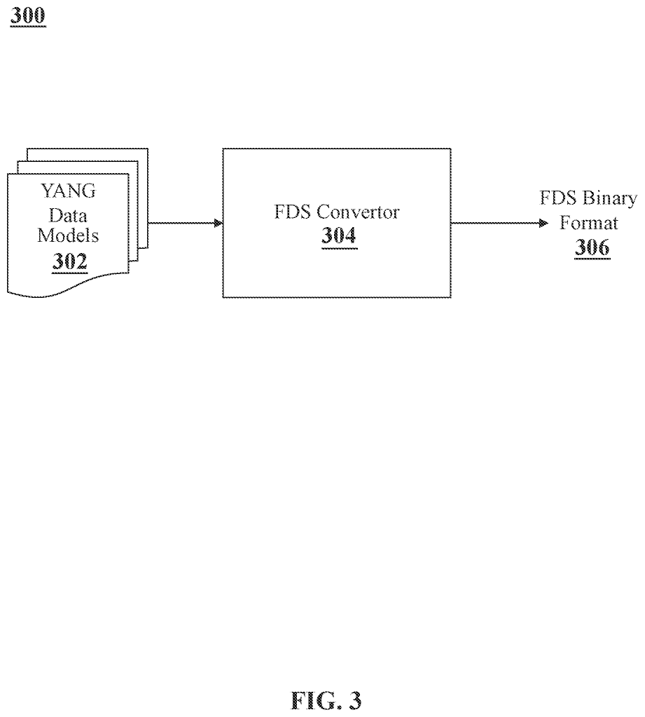

FIG. 3 illustrates a system 300 for conversion of YANG data models 302 to FDS binary format 306, in accordance with various non-limiting embodiments of the present disclosure. As shown, the system 300 may include YANG data models 302 (stored in a memory (not illustrated for the purpose of simplicity)), and an FDS convertor 304. It is to be noted that the system 300 may include other components but such components have been omitted from FIG. 3 for the purpose of simplicity.

It is to be noted that in certain non-limiting embodiments, the FDS convertor 304 may be implemented similar to the client device/network management system 110. The FDS convertor 304 may include one or more processors and one or more memory elements to store instructions to be executed by one or more processors.

In certain non-limiting embodiments, the system 300 may be a part of the environment 100 and may communicate with the client device/network management system 110 and the server-network device 114 via the communication network 112. The system 300 may be located at a remote location. In certain non-limiting embodiments, the system 300 may be distributed computing system, a virtual machine (or virtual machines) instantiated by the infrastructure of a public or private cloud, or a cloud service provider that provides the application programs as a service (SaaS). Such implementations or any other similar implementation should not limit the scope of the present disclosure.

In certain non-limiting embodiments, the FDS convertor 304 may be configured to receive the YANG data models 302 and may be configured to convert the YANG data models 302 into FDS binary format 306.

In certain non-limiting embodiments, the conversion may be based on high speed hash indexing. More particularly, the FDS convertor 304 may utilize full XPath string's hash value instead of processing the string text itself, thereby reducing XPath access time. The full XPath string of each node in the YANG data models and the associated hash code may be a global unique identifier of a given node. In other words, hashing of)(Path strings may be used as a global identifier of each node.

It is to be noted that in each in YANG data models, each node may have a global unique XPath; even though different nodes may have the same name, but as long as all ancestors are not identical, it is easy to identify the nodes. By way of example, a YANG data model may be represented as:

```
module example-base {
  namespace “urn: example: example-base”;
  prefix base;
  container base-container {
    leaf base-leaf {
      type string;
    }
  }
}
```

The full XPath of the leaf node may be represented as: /example-base/example-base:base-container/example-base:base-leaf

In certain non-limiting embodiments, the FDS convertor 304 may convert the above representation to a 32 bits hash code, and the hash code may be the unique identifier of the leaf node. The FDS convertor 304 may create a 32 bits integer to node data hash map, and the client device/network management system 110 may access the data with O(1) efficiency.

It is to be noted that in the original YANG data models, the when/must constraint may be an arithmetic formula with string format. In certain non-limiting embodiments, the FDS convertor 304 may convert when/must constraint statements from the string text to an operator/operand data structure. The original YANG data models may include constant values, node operators, pre-defined functions defined in infix order (e.g., x+y). In certain non-limiting embodiments, the FDS convertor 304 may create 2 types of tokens, one may be an operator, and another may be an operand. The operators may match with the original operator in the original YANG data models but with the predefined IDs. The predefined operator may act as a special operator as well. Further, the FDS convertor 304 may convert the constant values and nodes in the original YANG data models to operands. The operators and the operands may have their own data structure in the FDS binary format. The FDS convertor 304 may convert the infix order associated with the constant values, node operators, pre-defined functions in the original YANG data models to postfix orders and save the operators/operands in postfix order in FDS binary format (e.g., xy+). The conversion of the infix order to the postfix order expressions may allow the ease of formula loading and direct calculation.

Additionally, the FDS convertor 304 may convert each foreign XPath string to a hash code and store the mapping of the hash code to the actual node object. In doing so, the FDS convertor 304 may achieve node access with O(1) efficiency.

In certain non-limiting embodiments, the FDS binary format 306 corresponding to the YANG data models 302 may be divided into four areas by the FDS convertor 304. The four areas may be: i) forest data area, ii) meta-data area, iii) string area, and iv) dynamic area. Each area stores different types of data structures, and the combination of all four areas represent the full YANG data models 302. In each area, the FDS convertor 304 may rely on type-length-value (TLV) format when storing data. Additionally, the data may be nested in different areas as well.

In certain non-limiting embodiments, the forest data area may store nodes defined within the YANG data model 302. In certain non-limiting embodiments, the FDS convertor 304 may convert each YANG data model included in the YANG data models 302 into a respective tree structure, and the forest data area may include multiple tree structures corresponding to the YANG data model 302 therefore allowing to store several YANG models that reference to one another. Each tree structure may include a respective YANG data model “module/sub-module” node as a root node. In certain non-limiting embodiments, the FDS convertor 304 may embed other nodes within the respective YANG data model into the corresponding parent node's child node segment(s). In the case of leaf nodes, the node's data may be stored within the forest data area as well. Further, within the forest data area, the FDS convertor 304 may convert all string values into hash codes and may store the hash codes instead of the string content itself. Also, node attributes, node type and data type may be identified using predefined IDs.

In certain non-limiting embodiments, the meta-data area may store attributes specific to the respective YANG data model (root node) itself (e.g., YANG version, prefix) and the nodes that are used as definitions for other nodes (e.g., extension, identity) in the YANG data model. In certain non-limiting embodiments, predefined IDs may be used to identify the meta-data type. For meta-data values that are of type string, the FDS convertor 304 may convert the strings into hash codes and may store the hash codes instead of the string content itself.

As discussed above, within the forest data area and meta-data area, all string data were converted into a pre-calculated hash code that was then stored into the respective areas. In certain non-limiting embodiments, the FDS convertor 304 may store mappings from the hash codes to the string values to the string area. Additionally, the FDS convertor 304 may store the information regarding string length and compression flag in the string values to the string area.

In certain non-limiting embodiments, the string data may be retrieved, for example, by the server-network device 114, by accessing the string area and using the corresponding hash code, thereby improving the efficiency of the server-network device 114. It is to be noted that the string values are a low-frequency access resource. By removing the string values from high-frequency access areas such as the forest data area and the meta-data area, the size of the forest data area and the meta-data area may be significantly reduced and further improve overall performance of the server-network device 114.

In certain non-limiting embodiments, the dynamic area may store two types of YANG data structures: list and leaf-list. In certain non-limiting embodiments, the leaf nodes may include a single value of a specific type. In certain non-limiting embodiments, the list nodes may contain a sequence of list entries, each of which is uniquely identified by one or more key leaves. The list nodes may be a group of leaves with different types to form a schema and may add/modify/delete records of data in accordance with the schema. In certain non-limiting embodiments, the leaf-list node may include a sequence of leaf nodes. In certain non-limiting embodiments, each leaf-list node may include the type statement to identify the data type for valid data for that node's sequence of leaf nodes. The FDS convertor 304 may store list/leaf-list separately from the other nodes in the forest area because their data content may be dynamically increased and/or decreased during run-time.

In certain non-limiting embodiments, a client device/network management system for example the client device/network management system 110 may insert/remove data to/from the list and leaf-list nodes and each list/leaf-list node may include thousands of data records. These data records are stored in the dynamic area instead of the forest data area to reduce the data density of the forest data area. Moreover, the FDS convertor 304 may index the list/leaf-list global XPath hash codes from the forest data area to the dynamic area.

It is to be noted that typedef is a reserved keyword used to create an additional name (alias) for another data type, but may not create a new type, https://en.wikipedia.org/wiki/Typedef—cite note-K&R-1 except in the obscure case of a qualified typedef of an array type where the typedef qualifiers are transferred to the array element type. Typedef may be a custom-created type with a special name, however, Typedef may be traced to all built-in types like int/string, etc. in the YANG data models. In certain non-limiting embodiments, the FDS convertor 304 may trace all typedef types in the YANG data models and set the node in the YANG data models using built-in types to replace the custom-created type. In other words, the custom created types in the YANG data models may be replaced by the built-in types by the FDS convertor 304.

It is contemplated that a module may be referred to as a single YANG data model. In some cases, when all of the content of the module may not be included in one file, the content of the module may be spilt into other files referred to as sub-modules. Typically, a keyword “include” is used to add sub-modules to the main module. In certain non-limiting embodiments, the FDS convertor 304 may analyze the sub-modules and add all sub-modules' contents to the main module. In other words, the FDS convertor 304 may merge the sub-modules associated with the main module together to avoid complexity.

In some cases, some modules may use other modules' content like definitions, externally referenced nodes etc. Using of other modules' content may be referred to as “import”. In certain non-limiting embodiments, the FDS convertor 304 may trace and find the referred contents and update the main module accordingly. In doing so, in the FDS binary format, a requirement of importing other YANG models and tracing the referred contents during each access may be avoided.

It is to be noted that uses-grouping may be referred to as a predefined nodes set and the uses-grouping may have a specific name and may be reused at the place where “uses+grouping name” may be present. In certain non-limiting embodiments, the FDS convertor 304 may get the grouping contents and put the contents into the place where the “uses” presents directly to avoid searching and data adding.

It is to be noted that a node-augmentation may be referred to as, for example a first module defines some nodes, however, there is a requirement to add/update/delete some contents of the node, then the YANG data model may allow to create augment node in the second module. In certain non-limiting embodiments, the FDS convertor 304 may analyze the requirement to add/update/delete some contents of the node and may implement/perform the node-augmentation (e.g., add/update/delete) directly to the original nodes in the first module.

It is to be noted that similar to the node-augmentation, deviation may be another way that the YANG data model may allow the modification of the original node in the first module. In certain non-limiting embodiments, the FDS convertor 304 may perform the node-deviation in-place and change the original node in the first module. In other words, the FDS convertor 304 may perform node-deviation directly to the nodes associated with the first module. The FDS binary format may not require any node-deviation information.

In certain non-limiting embodiments, after converting YANG data models 302 into FDS binary format 306, the FDS convertor 304 may forward the FDS binary format 306 to the server-network device 114, via the communication network 112 to create and store data instances within a data store. In certain non-limiting embodiments, the network management clients such as client device/network management system 110 may then simultaneously access this data store in order to configure and monitor the network devices, ensure that configurations meet data constraints, and write to the data store as needed.

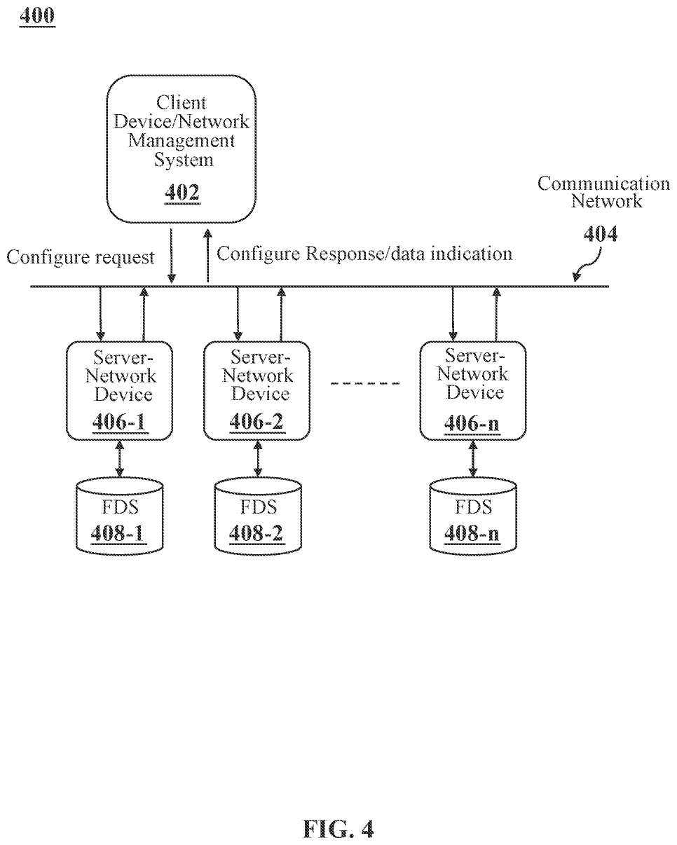

FIG. 4 illustrates a representative environment 400 including network devices for use with systems and methods, in accordance with various embodiments of the present disclosure. As shown, the representative environment 400 may include a client device/network management system 402, a communication network 404, a plurality of server-network devices 406-1, 406-2, . . . 406-n, a plurality of FDSs 408-1, 408-2, . . . 408-n. It is to be noted that the representative environment 400 may include other components, but such components have not been illustrated in FIG. 4 for the purpose of simplicity.

It is contemplated that that client device/network management system 402 may be implemented similar to the client device/network management system 110, the communication network 404 may be implemented similar to the communication network 112, the plurality of server-network devices 406-1, 406-2, . . . 406-n, may be implemented similar to the server-network device 114. Further, the plurality of FDSs 408-1, 408-2, . . . 408-n may be any suitable memory elements configured to store FDS binary format 306 as provided by the FDS convertor 304.

It is to be noted that the FDS binary format 306 may replace the functionality of YANG data models. In certain non-limiting embodiments, the FDS binary format 306 may allow network devices (such as the client device/network management systems 402 and the plurality of server-network devices 406-1, 406-2, . . . 406-n) to read and write configuration data to and from the plurality of FDSs 408-1, 408-2, . . . 408-n. It will be appreciated that the FDS binary format 306 may optimize the process of creating, reading, updating, deleting and verifying data operations.

The client device/network management system 402 may transmit a configure request towards one or more server-network devices 406-1, 406-2, . . . 406-n via the communication network 404. One or more server-network devices 406-1, 406-2, . . . 406-n may communicate with the plurality of FDSs 408-1, 408-2, . . . 408-n to process the configure request. One or more server-network devices 406-1, 406-2, . . . 406-n may process the configure request based on the FDS binary format 306. One or more server-network devices 406-1, 406-2, . . . 406-n may transmit a configure response/data indication towards the client device/network management system 402 via the communication network 404.

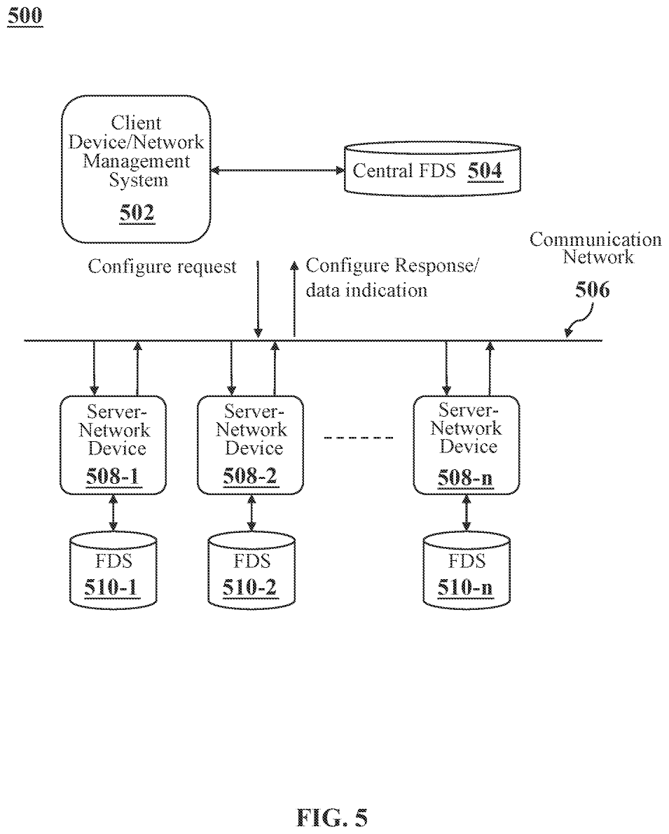

FIG. 5 illustrates a representative environment 500 including network devices for use with systems and methods, in accordance with various embodiments of the present disclosure. As shown, the representative environment 500 may include a client device/network management system 502, a central FDS 504, a communication network 506, a plurality of server-network devices 508-1, 508-2, . . . 508-n, a plurality of FDSs 510-1, 510-2, . . . 510-n. It is to be noted that the representative environment 500 may include other components, but such components have not been illustrated in FIG. 5 for the purpose of simplicity.

It is contemplated that that client device/network management system 502 may be implemented similar to the client device/network management system 110, the communication network 506 may be implemented similar to the communication network 112, the plurality of server-network devices 508-1, 508-2, . . . 508-n, may be implemented similar to the server-network device 114. Further, the central FDS 504, the plurality of FDSs 510-1, 510-2, . . . 510-n may be any suitable memory elements configured to store FDS binary format 306 as provided by the FDS convertor 304.

As previously discussed, the FDS binary format 306 may replace the functionality of YANG data models. In certain non-limiting embodiments, the FDS binary format 306 may allow network devices (such as the client device/network management systems 502 and the plurality of server-network devices 508-1, 508-2, . . . 508-n) to read and write configuration data to and from the plurality of FDSs 510-1, 510-2, . . . 510-n. In certain non-limiting embodiments, the central FDS 504 may also include the FDS binary format 306. It will be appreciated that the FDS binary format 306 may optimize the process of creating, reading, updating, deleting and verifying data operations.

The client device/network management system 502 may transmit a configure request towards one or more server-network devices 508-1, 508-2, . . . 508-n via the communication network 506. In certain non-limiting embodiments, the client device/network management system 502 may generate the configure request in accordance with the FDS binary format 306 stored in the central FDS 504. In certain non-limiting embodiments, data unions associated with the plurality of FDSs 510-1, 510-2 . . . 510-n. The client device/network management system 502 may perform a request validation by consulting the central FDS 504 prior to sending the request towards one or more-server-network devices 508-1, 508-2, . . . 508-n. One or more server-network devices 508-1, 508-2, . . . 508-n may communicate with the plurality of FDSs 510-1, 510-2, . . . 510-n to process the configure request. One or more server-network devices 508-1, 508-2, . . . 508-n may process the configure request based on the FDS binary format 306. One or more server-network devices 508-1, 508-2, . . . 508-n may transmit a configure response/data indication towards the client device/network management system 502 and the central FDS 504 via the communication network 506.

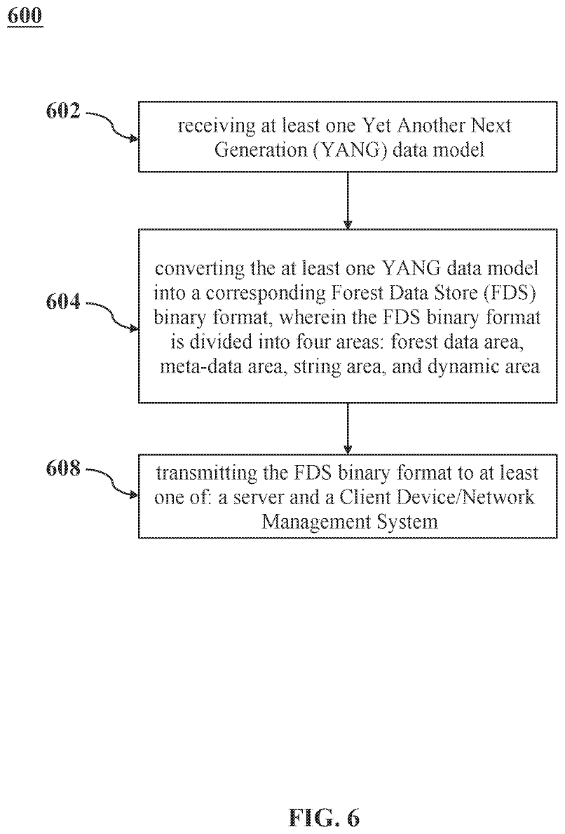

FIG. 6 depicts a flowchart representing a process 600 corresponding to a method for improving efficiency of YANG data model-based network devices, in accordance with various embodiments of the present disclosure. As shown, the process 600 commences at step 602 where the FDS convertor 304 receives at least one YANG data model. As previously noted, in certain non-limiting embodiments, the FDS convertor 304 may be configured to receive the YANG data models 302.

The process 600 advances to step 604 where the FDS convertor 304 converts the at least one YANG data model into a corresponding FDS binary format. The FDS binary format is divided into four areas: forest data area, meta-data area, string area, and dynamic area. As previously noted, the FDS convertor 304 may be configured to convert the YANG data models 302 into FDS binary format 306. Also, in certain non-limiting embodiments, the FDS binary format 306 corresponding to the YANG data models 302 may be divided into four areas by the FDS convertor 304. The four areas may be: i) forest data area, ii) meta-data area, iii) string area, and iv) dynamic area.

Finally, at step 608, the FDS convertor 304 transmits the FDS binary format to at least one of: a server and a client device/Network Management System. As previously noted, in certain non-limiting embodiments, after converting YANG data models 302 into FDS binary format 306, the FDS convertor 304 may forward the FDS binary format 306 to the server-network device 114, via the communication network 112 to create and store data instances within a data store.

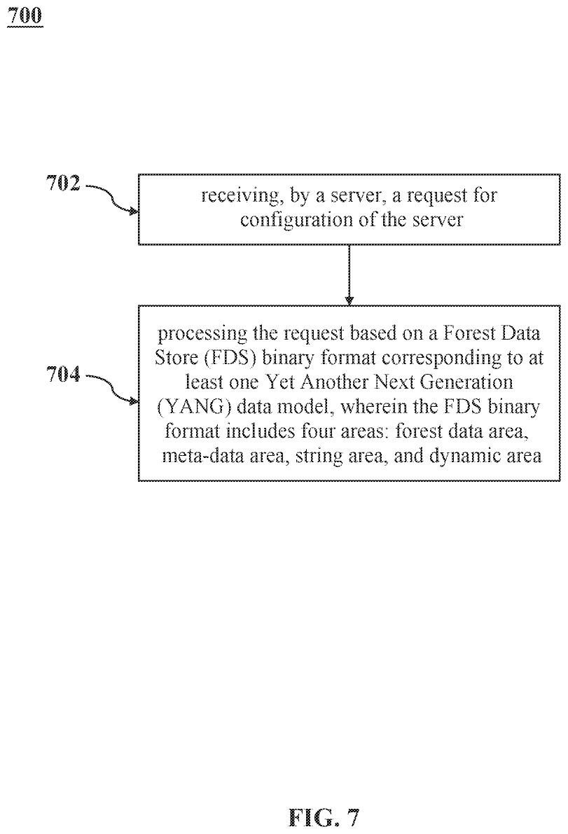

FIG. 7 depicts a flowchart representing a process 700 corresponding to a method for processing a configure request based on FDS binary format implementing on the server-network device 114. As shown, the process 700 commences at the step 702 where the server receives a request for configuration of the server. As previously discussed, the server 114 may receive a request for configuration.

The process 700 advances to step 704 where the server 114 processes the request based on the FDS binary format 306 corresponding to at least one YANG data model, wherein the FDS binary format 306 includes four areas: forest data area, meta-data area, string area, and dynamic area.

It is to be understood that the operations and functionality of environment 100, constituent components, and associated processes may be achieved by any one or more of hardware-based, software-based, and firmware-based elements. Such operational alternatives do not, in any way, limit the scope of the present disclosure.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A method comprising:
receiving at least one Yet Another Next Generation (YANG) data model;
converting the at least one YANG data model into a corresponding Forest Data Store (FDS) binary format, wherein the FDS binary format is divided into four areas: forest data area, meta-data area, string area, and dynamic area; and
transmitting the FDS binary format to at least one of: a server-network device and a client device/network management system.

2. The method of claim 1, wherein the meta-data includes attributes specific to the at least one YANG data model.

3. The method of claim 1, wherein the meta-data includes nodes that are used as definitions for other nodes in the at least one YANG data model.

4. The method of claim 1, wherein the forest data includes a tree structure corresponding to the at least one YANG data model.

5. The method of claim 1, wherein string values in the at least one YANG data model are converted into hash codes and the hash codes are stored in one or more of the forest data area, the meta-data area, the string area and the dynamic area.

6. The method of claim 5, wherein the string area includes mappings from the hash codes to the string values.

7. The method of claim 1, wherein the string area includes information regarding string length and compression flag in the string values.

8. The method of claim 1, wherein the dynamic area includes list nodes and leaf-list nodes associated with the at least one YANG data model.

9. The method of claim 1, wherein the FDS binary format is a machine-readable format.

10. The method of claim 1, wherein constant values, node operators, and pre-defined functions associated with the at least one YANG data model defined as infix order are converted to postfix order in the FDS binary format.

11. The method of claim 1 further comprising converting XPath strings in the at least one YANG data model to hash codes and the hash codes are used as a global identifier for each node in the YANG data model.

12. The method of claim 1 further comprising replacing custom created typedef in the at least one YANG data model by built-in type(s).

13. The method of claim 1 further comprising merging sub-modules associated with the at least one YANG data model.

14. The method of claim 1 further comprising importing of content associated with other YANG data models to the FDS binary format.

15. The method of claim 1 further comprising performing node-augmentation directly to nodes associated with the at least one YANG data model.

16. The method of claim 1 further comprising performing node-deviation directly to nodes associated with the at least one YANG data model.

17. The method of claim 1 further comprising reusing of uses-grouping.

18. A method comprising:
receiving, by a server-network device, a request for configuration of the server-network device; and
processing the request based on a Forest Data Store (FDS) binary format corresponding to at least one Yet Another Next Generation (YANG) data model, wherein the FDS binary format includes four areas: forest data area, meta-data area, string area, and dynamic area.

19. A system comprising:
a non-transitory memory element having instructions thereon;
one or more processor coupled to the non-transitory memory element to execute the instructions to cause the one or more processor to:
receive at least one Yet Another Next Generation (YANG) data model;
convert the at least one YANG data model into a corresponding Forest Data Store (FDS) binary format, wherein the FDS binary format is divided into four areas: forest data area, meta-data area, string area, and dynamic area; and
transmit the FDS binary format to at least one of: a server-network device and a client device/network management system.

20. A server-network device comprising:
a non-transitory memory element having instructions thereon;
one or more processor coupled to the non-transitory memory element to execute the instructions to cause the one or more processor to:
receive a request for configuration of the server-network device; and
process the request based on a Forest Data Store (FDS) binary format corresponding to at least one Yet Another Next Generation (YANG) data model, wherein the FDS binary format includes four areas: forest data area, meta-data area, string area, and dynamic area.
